(19) United States
(12) Patent Application Publication
(10) Pub. No.: US 2015/0170137 A1
(43) Pub. Date: Jun. 18, 2015

(54) SMARTPHONE APPLICATION ENABLING INSTANT ACTIVATION OR DEACTIVATION OF CREDIT CARDS WITH THE TOUCH OF A BUTTON

(71) Applicant: Tal Balbus, Cedarhurst, NY (US)

(72) Inventor: Tal Balbus, Cedarhurst, NY (US)

(21) Appl. No.: 14/571,705

(22) Filed: Dec. 16, 2014

Related U.S. Application Data
(60) Provisional application No. 61/916,607, filed on Dec. 16, 2013.

(51) Int. Cl. G06Q 20/34

(52) U.S. Cl. CPC G06Q 20/354

(57) ABSTRACT

A method of activating and deactivating credit cards or debit cards by initiating activation or deactivation of a credit card or debit card in an application, transmitting an activate signal or deactivate signal to a server of a card issuer, validating user information, and activating or deactivating the credit card or debit card. A method of preventing fraudulent charges on a credit card or debit card. A method of using credit cards and debit cards by deactivating a credit card or debit card when not in use, and activating the credit card or debit card when use is needed.

### BACKGROUND OF THE INVENTION

1. Technical Field

The present invention relates to activation and deactivation of credit cards. More specifically, the present invention relates to smartphone applications that activate and deactivate credit cards.

2. Background Art

Many people now use credit and debit cards to pay for their purchases, both in stores and online. Many people also have multiple cards, whether issued for different stores or different banks. When someone loses a card, or has their credit card stolen (whether physically or the data on the card), their card must be deactivated. Deactivating a lost, stolen, or unauthorized credit card is a long, indirect and cumbersome process that can only be done via phone call and through the involvement of a 3rd party (the credit card company). While some sophisticated wallets try to prevent the physical theft of a card, these devices are cumbersome, expensive, prevent only certain kinds of theft, and, most importantly, do not provide the user with any immediate power to control when their cards may or may not be used. RFID wallets and card sleeves also exist to prevent data from being read unknowingly from a card, but these also do not give a user ultimate control over their cards.

U.S. Patent Application Publication No. 20120259779 to Bharghavan, et al. discloses systems and methods for cashless peer-to-peer payment. Generally, the consumer is able to go to the server website (whether by a computer or handheld computing devices) to make or receive a payment. On the website, the consumer enters payment credentials, receives a notification when the payment is complete, and optionally requests a receipt to be delivered asynchronously via email or SMS. The transaction occurs over an existing payment infrastructure and the payer's and payee's credit or debit cards. Bharghavan, et al. does not disclose or suggest the ability to activate or deactivate credit or debit cards over a server, and merely describes methods of payment to a server.

Therefore, there remains a need for the ability of a user of a credit or debit card to activate or deactivate their card in a simple and convenient manner.

### SUMMARY OF THE INVENTION

The present invention provides for a method of activating and deactivating credit cards or debit cards, initiating activation or deactivation of a credit card or debit card in an application, transmitting an activate signal or deactivate signal to a server of a card issuer, validating user information, and activating or deactivating the credit card or debit card.

The present invention also provides for a method of preventing fraudulent charges on a credit card or debit card, by initiating deactivation of a credit card or debit card in an application, transmitting a deactivate signal to a server of a card issuer, validating user information, deactivating the credit card or debit card, preventing fraudulent charges, when a user desires to use the credit card or debit card, initiating activation of a credit card or debit card in the application, transmitting an activate signal to a server of the card issuer, validating user information, and activating the credit card or debit card.

The present invention also provides for a method of using credit cards and debit cards by deactivating a credit card or debit card when not in use, and activating the credit card or debit card when use is needed.

### DESCRIPTION OF THE DRAWINGS

Other advantages of the present invention are readily appreciated as the same becomes better understood by reference to the following detailed description when considered in connection with the accompanying drawings wherein:

FIG. 1 is a view of a login page of the application of the present invention;

FIG. 2 is a view of credit cards stored in the application;

FIG. 3 is a view of an add new card button;

FIG. 4 is a view of new card details;

FIG. 5 is a view of a settings button;

FIG. 6 is a view of a reset mechanism;

FIG. 7 is a view of a password request;

FIG. 8 is a flowchart of the method of the application; and

FIG. 9 is a depiction of the flow of information between the application and a credit card or bank server.

### DETAILED DESCRIPTION OF THE INVENTION

The present invention generally provides for methods of activating and deactivating credit cards or debit cards by toggling a single button, preferably on a mobile device application. Most generally, the present invention is directed to a method of using credit cards and debit cards by deactivating a credit card or debit card when not in use, and activating the credit card or debit card when use is needed. The method of the present invention allows users to immediately prevent stolen credit cards or stolen credit card information from being used. The method also allows credit card owners to block use of their credit cards at any time, for any reason, at the touch of a button.

“Credit cards” as used herein include any type of card issued by a bank or business that allows the owner of the card to purchase goods or services on credit. “Debit cards” as used herein, include any type of card issued by a bank that allows the owner to transfer money electronically to another bank account when making a purchase. Credit cards and debit cards can include gift cards or pre-paid cards that contain a set amount of money thereon. It should be understood that “credit cards” and “debit cards” can be used interchangeably herein.

The term “application” as used herein refers to a computer software application, otherwise known as an “app”, that is stored on computer readable media, run, and operated on a mobile device, especially ones utilizing a touch screen. It should also be understood that the application can also be run on desktop computers that support applications or there can be a separate desktop interface accessible via a website that corresponds to the application.

The term “mobile device” as used herein refers to any type of portable computing device, such as, but not limited to, smartphones (IPHONE® (Apple, Inc.), ANDROID™ devices (Google, Inc.), WINDOWS® devices (Microsoft)), mp3 players (IPOD TOUCH® (Apple, Inc.)), or tablet computers (IPAD® (Apple, Inc.), Microsoft SURFACE)).

The term “activate” or “activation” as used herein refers to turning on a credit card or debit card such that it can be used to pay for a purchase. The term “deactivate” or “deactivation” as used herein refers to turning off a credit card or debit card such that it cannot be used to pay for a purchase.

In general, in order to deactivate a card, the method includes toggling a deactivate button for a credit card or debit card in an application, transmitting a deactivate signal to a server of a card issuer, validating user information, and deactivating the credit card or debit card. In order to activate a card, the method includes toggling an activate button in the application for a credit card or debit card, transmitting an activate signal to a server of the card issuer, validating user information, and activating the credit card or debit card.

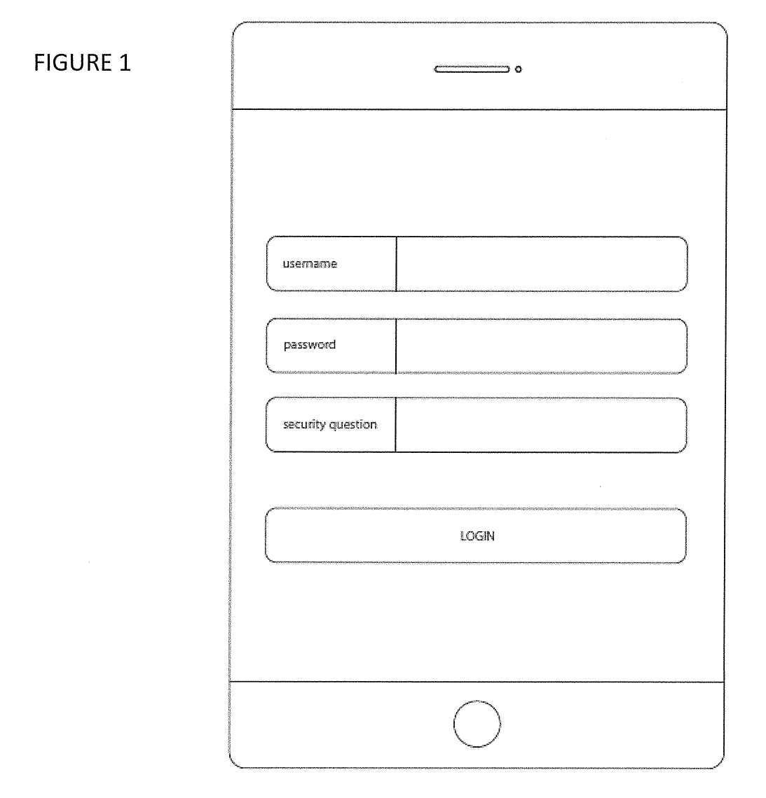

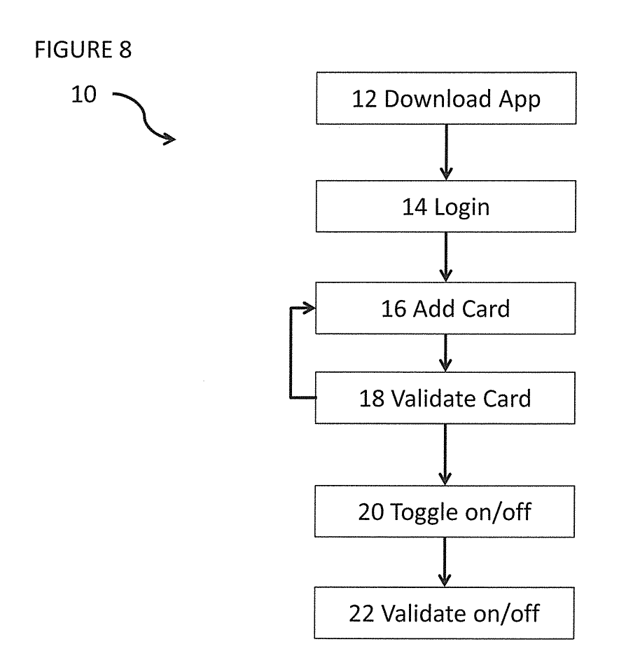

More specifically, the method can be performed as follows, and as shown generally in FIG. 8 at 10. A user downloads the application (12) from a website or from a database of applications (i.e. iTunes®). A username, password, and security question can be set up upon downloading and launching the application (FIG. 1) with a mobile device. The user enters this user information and presses the “Login” button on the home screen to then enter the application (14).

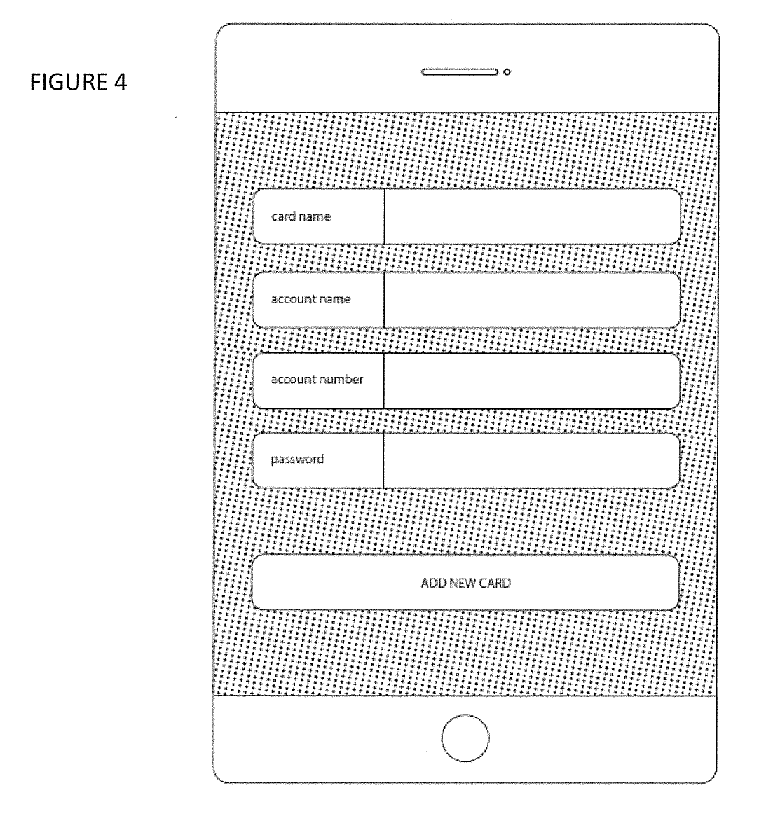

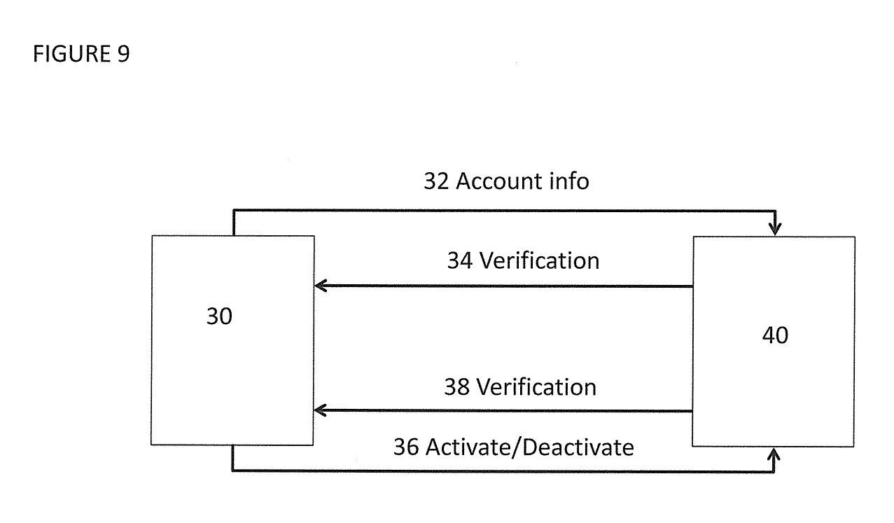

The user then registers at least one credit card or debit card by adding a new card (shown in FIG. 4, and step 16 in FIG. 8) such as by entering the name on the card (i.e. account name), card number (account number), expiration date, card security code (CSC, also called card verification data (CVD), card verification number (CVN), card verification value (CVV or CVV2), card verification code (CVVC), verification code (V-code), card code verification (CVV)), type of card, issuing company, issuing bank, routing number, password for the account, etc., or combinations thereof. A nickname for the card can be created. As shown in FIG. 9, the card can be validated by the application (30) sending any of the above account information (32) wirelessly (i.e. via wireless Internet signals or via cellular data signals) to a server (40) of the issuing bank or credit card company, and receiving a verification (34) back from the server of the issuing bank or credit card company (18). It should be understood that any or all information or signals sent or received by the application can be encrypted by an encryption mechanism and by any suitable encrypting software with appropriate security.

The user toggles an “on” (i.e. activated) or “off” (i.e. deactivated) default setting for each card (20). Once entered into the application, one tap of a button allows the user to instantly activate or deactivate one or more cards. The toggling of the “on” or “off” button transmits an (encrypted) activation or deactivation signal (36) wirelessly to a server (40) of the issuing credit card company or bank. When the credit card company or bank's server (40) recognizes and validates the user's information (22), the user is logged into their account and their activation or deactivation choice is implemented by the credit card company or bank's system to either activate or deactivate the card. A verification signal (38) can be sent back from the server (40) of the issuing credit card company or bank to the application (30), notifying the user that the activation or deactivation was successful, as shown in FIG. 9. In real time, this entire process can take only a few seconds. When a user taps to deactivate a card, the card cannot be used until it is (re)activated from the application. In other words, a deactivated card is unusable and an activated card is usable. Each card is set to an active (on) or deactive (off) status at all times. This simple and quick functionality protects credit card and debit card owners from theft, identity fraud, or misuse by children. For example, the method can be performed immediately after learning of a theft of the credit card or debit card to prevent fraudulent charges. Alternatively, cards can be set to a deactive status anytime they are not desired to be in use, reducing the chances of theft.

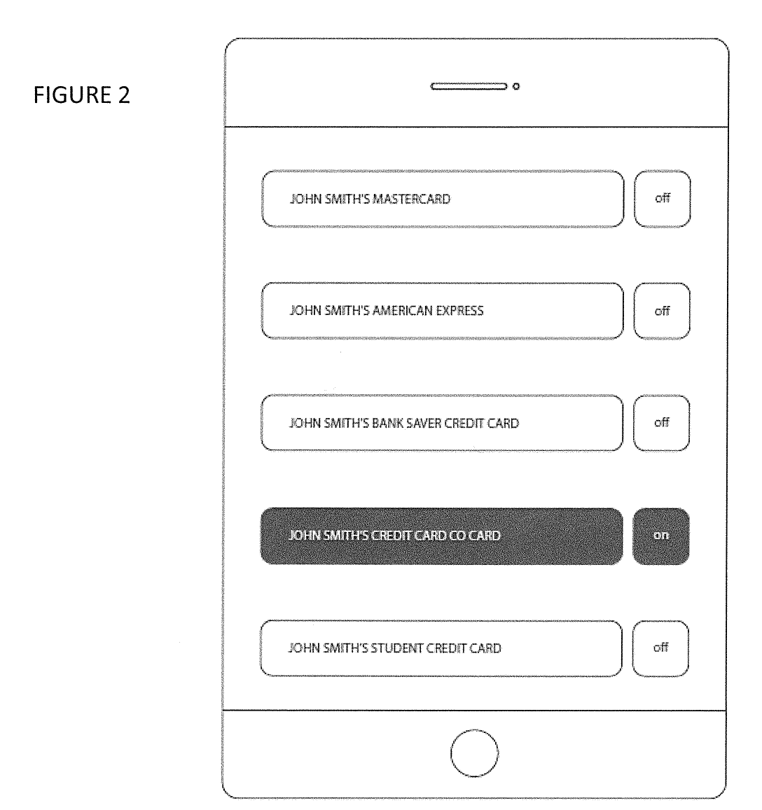

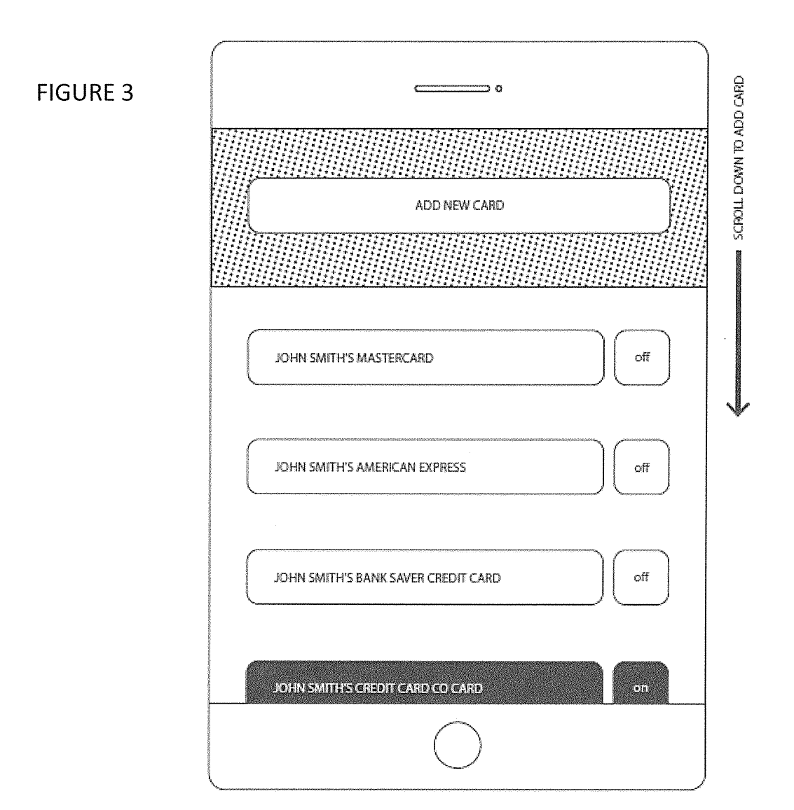

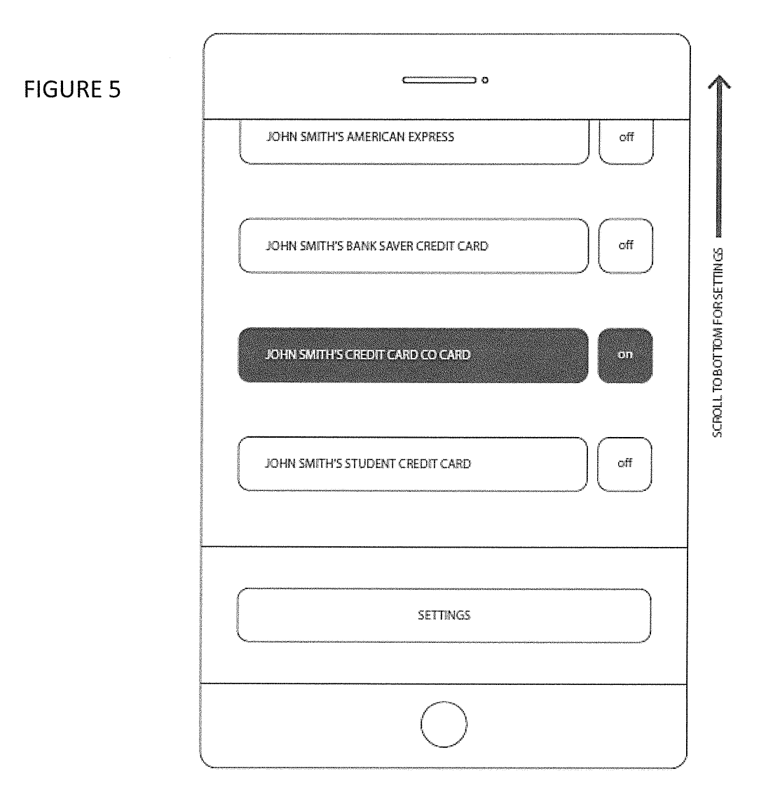

Each of the registered cards can be displayed in the application, along with their status of being “on/activated” or “off/deactivated”. An example of the display of various credit and debit cards is shown in FIG. 2. A new card can be added at a later time by swiping or scrolling in a particular direction on the mobile device display to toggle an “Add New Card” button, as shown in FIG. 3 by swiping down. Alternatively, a settings button can be toggled to access various options for the application including adding a new card, shown in FIG. 5 as being accessed by scrolling to the bottom of the display in the application.

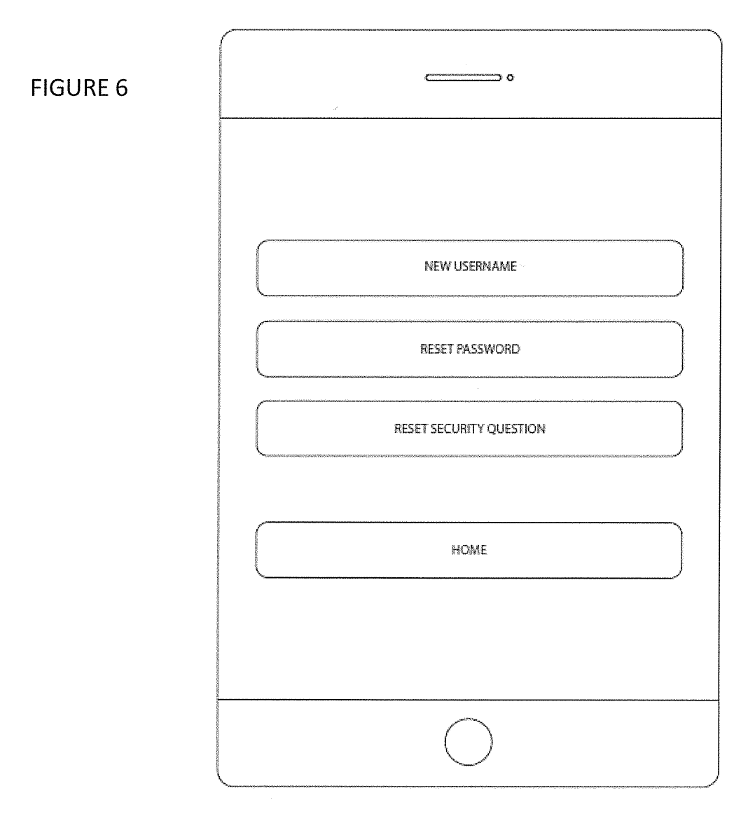

The application provides a reset mechanism that can be toggled, shown in FIG. 6, that allows a user to reset their login information. The user can enter a new username, reset their password, and reset their security question. All information previously stored in the application can be saved and accessed again once any of the desired information has been reset.

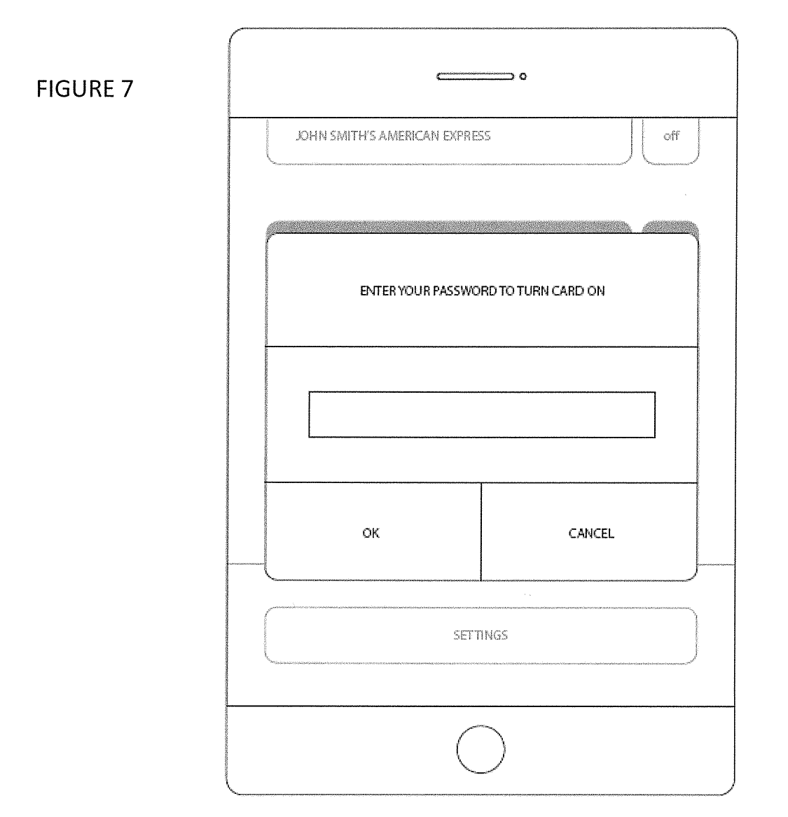

The application can optionally require that the user enter their password in order to toggle their card to “on”, as shown in FIG. 7. This can add extra security for the user.

The application can be coded in language such as, but not limited to Ruby, Python, Lua, Scheme, Lisp, Smalltalk, C#, Haskell, ActionScript, JavaScript, Objective-C, C++, or C.

The present invention also provides for a method of preventing fraudulent charges on a credit card or debit card, by toggling a deactivate button for a credit card or debit card in an application, transmitting a deactivate signal to a server of a card issuer, validating user information, deactivating the credit card or debit card, preventing fraudulent charges, when a user desires to use the credit card or debit card, toggling an activate button for a credit card or debit card in the application, transmitting an activate signal to a server of the card issuer, validating user information, and activating the credit card or debit card. Each of these steps can be performed as described above. In order to secure the credit card or debit card again once activated, the toggling a deactivated button, transmitting, validating, deactivating and preventing steps can be repeated once a purchase has been completed and the user does not desire to use the card further.

The application and any or all of its features can also be integrated into existing banking and credit card applications for mobile devices. For example, many banks offer applications that allow users to access their account details, make transfers, and deposit checks. Credit cards offer applications that allow a user to pay from the application (whether from the credit card company itself or linked to another application such as GOGGLE WALLET™ or APPLE PAY™), check their balance, view account details, and pay their bills. In other words, smart phone apps (or other application containing devices) can now function as a credit card or debit card, i.e. a virtual credit card. The application of the present invention can be integrated to allow a user to turn their credit card or debit card on or off from their specific banking or credit card application, increasing the value of the features of the existing applications. The user can use the existing application to pay for a purchase when the credit card or debit card is activated by the steps of the present invention. Alternatively, the application itself can include a function that allows a user to pay with a selected card that is activated. The application can also be integrated into Ondot Card Control mobile application.

The application is not limited to use with credit cards and debit cards. It can also be used to activate or deactivate other functions, such as bank accounts, brokerage control, or even passwords for websites or other software. In the future, this application can completely obviate the need for passwords by allowing users to simply activate or deactivate website accounts with one button touch.

The present invention provides the advantage of circumventing and expediting the previously long, indirect, and cumbersome process to deactivate cards that could only be done via phone call with the credit card company, and would routinely obviate the need to involve them at all. Further, the invention provides the user with a much greater and more powerful ability to control when their cards may or may not be used.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. A method of activating and deactivating credit cards or debit cards, including the steps of:
initiating activation or deactivation of a credit card or debit card in an application;
transmitting an activate signal or deactivate signal to a server of a card issuer;
validating user information; and
activating or deactivating the credit card or debit card.

2. The method of claim 1, wherein said initiating activation step is further defined as toggling an activate button for a credit card or debit card in the application.

3. The method of claim 1, further including after said activating step, the step of sending a verification signal from the server to the application and confirming that said activating step was successful.

4. The method of claim 1, further including, prior to said transmitting an activate signal step, the step of entering a user password.

5. The method of claim 1, wherein said initiating deactivation step is further defined as toggling a deactivate button for a credit card or debit card in the application.

6. The method of claim 1, further including after said deactivating step, the step of sending a verification signal from the server to the application and confirming that said deactivating step was successful.

7. The method of claim 5, wherein the deactivate button is an off button.

8. The method of claim 1, wherein the deactivated credit card or debit card cannot be used until activated by a user, and further including the step of preventing theft of the credit card or debit card.

9. The method of claim 1, wherein said initiating deactivation step is performed after learning of a theft of the credit card or debit card.

10. The method of claim 1, further including, prior to said initiating step, the steps of downloading an application, entering user information, and logging into the application.

11. The method of claim 1, further including the step of registering at least one credit card or debit card by entering information chosen from the group consisting of the name on the card, card number, expiration date, card security code, type of card, issuing company, issuing bank, routing number, password for the account, and combinations thereof.

12. The method of claim 11, further including the step of validating the credit card or debit card by sending the information to a server of the card issuer.

13. The method of claim 12, further including the step of sending a verification signal from the server to the application.

14. The method of claim 11, further including the step of toggling an add new card button and performing said registering step.

15. The method of claim 1, wherein the status of the credit cards or debit cards as activated or deactivated is displayed in the application.

16. The method of claim 1, wherein the application is stored on computer readable memory on a mobile device chosen from the group consisting of smartphones, mp3 players, and tablet computers.

17. The method of claim 1, wherein the application is stored on computer readable memory on a desktop computer.

18. The method of claim 1, wherein the deactivate signals, activate signals, and verification signals are encrypted.

19. The method of claim 1, further including the step of toggling a reset mechanism and resetting login information.

20. The method of claim 1, wherein the application is integrated into an existing application chosen from the group consisting of a banking application and a credit card application.

21. The method of claim 20, further including the step of using the existing application to pay for a purchase when the credit card or debit card is activated.

22. A method of preventing fraudulent charges on a credit card or debit card, including the steps of:
initiating deactivation of a credit card or debit card in an application;
transmitting a deactivate signal to a server of a card issuer;
validating user information;
deactivating the credit card or debit card;
preventing fraudulent charges;
when a user desires to use the credit card or debit card, initiating activation of a credit card or debit card in the application;
transmitting an activate signal to a server of the card issuer;
validating user information; and
activating the credit card or debit card.

23. The method of claim 22, further including the steps of repeating said toggling a deactivated button, transmitting, validating, deactivating and preventing steps once a purchase has been completed.

24. A method of using credit cards and debit cards, including the steps of:
deactivating a credit card or debit card when not in use; and
activating the credit card or debit card when use is needed.
